(19) United States
(12) Patent Application Publication
(10) Pub. No.: US 2003/0145941 A1
(43) Pub. Date: Aug. 7, 2003

(54) Method and apparatus for manufacturing an optical disc

(76) Inventor: Shinichi Hanzawa, Nakakoma-gun (JP)

Correspondence Address: PERMAN & GREEN, 425 POST ROAD, FAIRFIELD, CT, 06824, US

(21) Appl. No.: 10/326,696

(22) Filed: Dec. 20, 2002

(30) Foreign Application Priority Data
Feb. 7, 2002 (JP) 2002-30484

(51) Int. Cl. B32B 31/00

(52) U.S. Cl. 156/275.7; 156/356; 427/512

(57) ABSTRACT

Method and apparatus for manufacturing an optical disc having a light-transmitting layer of a uniform thickness over the entire surface of a substrate is provided whereon a recording and/or a reproducing of information signals is carried out by a light input through the light-transmitting layer.

In forming a recording layer and a light-transmitting layer on a substrate 1, an ultraviolet curable resin in the liquid phase is dripped on the recording layer of the substrate 1. The substrate 1 whereon the ultraviolet curable resin being dripped is rotated by a stage 12 around a rotating shaft with which the center of the substrate 1 is aligned while keeping thetemperature around a radially outer portion of the substrate 1 higher than that around a radially inner portion of the substrate 1 by heaters 16, so as to expand the ultraviolet curable resin over the entire surface of the recording layer. The expanded ultraviolet curable resin is then cured by an ultraviolet light so as to form the light-transmitting layer.

### BACKGROUND OF THE INVENTION

1) Field of the Invention

The present invention relates to method and apparatus for manufacturing an optical disc having a light-transmitting layer.

2) Description of the Related Art

An optical disc has a configuration comprising an optical recording layer, a protective layer covering the optical recording layer, and a transparent resin substrate having lands and grooves on one side formed by means of injection-molding so that the protective layer and the optical recording layer are formed on the side. Another type of optical disc has a configuration comprising two transparent resin substrates each having an optical recording layer which are bonded to each other by a resin intermediate layer in between so that the optical recording layers face each other. The optical discs having such configurations are used for recording and reproducing information signals on the recording layer by irradiating a laser light through the transparent resin substrate on the recording layer.

With an optical disc having the above-mentioned configuration, a recording capacity can be increased by maximizing recording density which is realized by using a laser beam having a short wavelength or using a large numerical aperture of objective lens in an optical pick-up system. The laser beam having a short wavelength is however liable to increase aberration in the optical pick-up system. This problem can be solved by decreasing and keeping uniform thickness of the layer through which the laser light passes.

Being apparent from the above, to increase the recording capacity of the optical disc having the configuration described above requires minimization of the thickness of the substrate in order to complywith the laser light having a short wavelength. However, it is difficult to increase the recording capacity in such a manner, since minimization of the thickness of the substrate by means of injection-molding has a limitation.

Much effort has thus been expended to develop an optical disc of a specific type comprising an optical recording layer formed on a substrate and a light-transmitting layer having a thin thickness and having a light-transmissive feature formed on the optical recording layer through which the laser light is irradiated onto the optical recording layer. The optical disc of such type can be manufactured by such method as the spin-coating of a resin which makes possible to form a light-transmitting layer having a thin thickness, which thus enables to manufacture an optical disc complying with a laser light having a short wavelength.

Although the spin-coating method mentioned above is advantageous in getting a light-transmitting layer having a thin thickness, the method is liable to form a non-uniform layer causing optical aberration, which results in deterioration in recording and/or reproducing characteristics of information signals.

### SUMMARY OF THE INVENTION

It is therefore an object of the present invention to provide method and apparatus for manufacturing an optical disc while realizing a substantially uniform thickness of the light-transmitting layer over the entire surface of the optical disc.

According to claim 1, there is provided a method of manufacturing an optical disc, having a recording layer and a light-transmitting layer formed on a substrate, whereon a recording and/or a reproducing of information signals are carried out by a light input through said light-transmitting layer, the method comprising the steps of;

a first step of supplying an ultraviolet curable resin in the liquid phase on a central area of the recording layer, and expanding said ultraviolet curable resin over said recording layer while keeping the temperature around a radially outer portion of said substrate higher than that around a radially inner portion of said substrate and while rotating said substrate around a rotating shaft aligned with the center of said substrate, and

a second step of curing said expanded ultraviolet curable resin so as to form said light-transmitting layer.

According to claim 3, there is provided a method of manufacturing an optical disc, having a recording layer and a light-transmitting layer formed on a substrate, whereon a recording and/or a reproducing of information signals are carried out by a light input through said light-transmitting layer, the method comprising the steps of;

a supplying step of supplying an ultraviolet curable resin in the liquid phase on a central area of the recording layer of said substrate,

a first step of overlapping a resin film on the substrate whereon said ultraviolet curable resin is already supplied, and expanding said ultraviolet curable resin between said resin film and said recording layer while keeping the temperature around a radially outer portion of said substrate higher than that around a radially inner portion of said substrate and while rotating said substrate around a rotating shaft aligned with the center of said substrate, and

a second step of curing said expanded ultraviolet curable resin so as to form said light-transmitting layer together with said resin film.

According to the description of claim 5 of the present invention, an apparatus for manufacturing an optical disc having a recording layer and a light-transmitting layer on a circular substrate, whereon a recording and/or a reproducing of information on the recording layer is carried out by a light input through said light-transmitting layer, comprising;

a rotating stage which rotates said substrate around a rotating shaft aligned with the center of said substrate placed on the stage,

a resin supplier which supplies the ultraviolet curable resin on a central area of the substrate placed on said rotating stage,

one or more heaters provided around a radially outer portion of the substrate placed on said rotating stage, and

a controller which controls said rotating stage, said resin supplier, and said heaters.

### BRIEF DESCRIPTION OF THE DRAWINGS

FIG. 1 is a diagram showing a configuration of an apparatus for manufacturing an optical disc according to the present invention;

FIG. 2 is a top view of the apparatus shown in FIG. 1;

FIG. 3 is a diagram showing another configuration of heaters used for the apparatus for manufacturing the optical disc according to the present invention;

FIGS. 4A-C are diagrams illustrating one embodiment of method for manufacturing the optical disc according to the present invention;

FIG. 5 is a graph depicting a state of rotation of a rotating stage used for the method in FIG. 3;

FIG. 6 is a graph depicting a radial distribution of a thickness of the light-transmitting layer on the optical disc manufactured according to the present invention;

FIGS. 7A-C are diagrams illustrating second embodiment of method for manufacturing the optical disc according to the present invention; and

FIG. 8 is a graph depicting a radial distribution of a thickness of the light-transmitting layer on the optical disc manufactured according to the method shown in the second embodiment.

### DETAILED DESCRIPTION OF THE INVENTION

Preferred embodiments of the present invention will be described hereinafter while referring to the drawings.

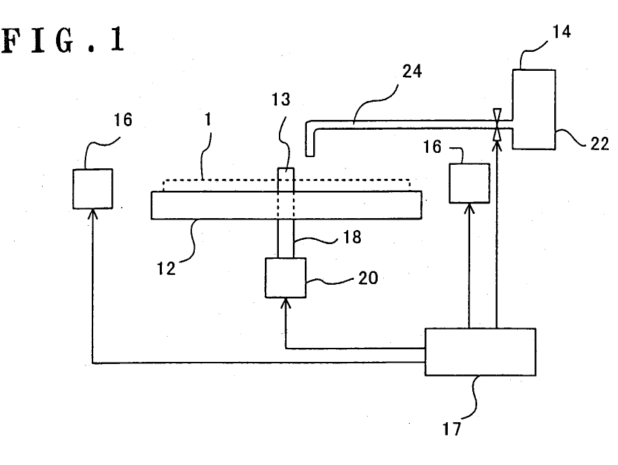

In FIG. 1, an apparatus 10 for manufacturing the optical disc which is an embodiment of the present invention is shown. The apparatus 10 for manufacturing the optical disc comprises a rotating stage 12 whereon a substrate 1 of the optical disc is placed, a resin supplier 14, one or more heaters 16 provided around the rotating stage 12 and a controller 17.

The substrate 1 is placed on a main surface of the rotating stage 12, the substrate 1 is then fixed to the rotating stage 12 by appropriate fixing means such as a spindle 13 or by fastening means such as a clump so as to align the center of the substrate 1 with a rotating shaft 18 of the rotating stage 12. The substrate 1 is thus rotated by a motor 20 during a specified period at the specified number of rotation.

The resin supplier 14 comprises a tank 22 to reserve the resin to be applied on the substrate 1, and a lead pipe 24 which leads the resin from the tank 22 to the rotating stage 12. An outlet of the lead pipe 24 is directed so as not to face the center of the rotating stage 12 but to face an off-centered position, for example, approximately 20 mm radially apart from the center of the rotating stage 12. Even though the resin supplier 14 supplies the resin on the central area of the recording layer by dripping, the supplier 14 can supply the resin in either manner of dripping, flowing, injecting or the like.

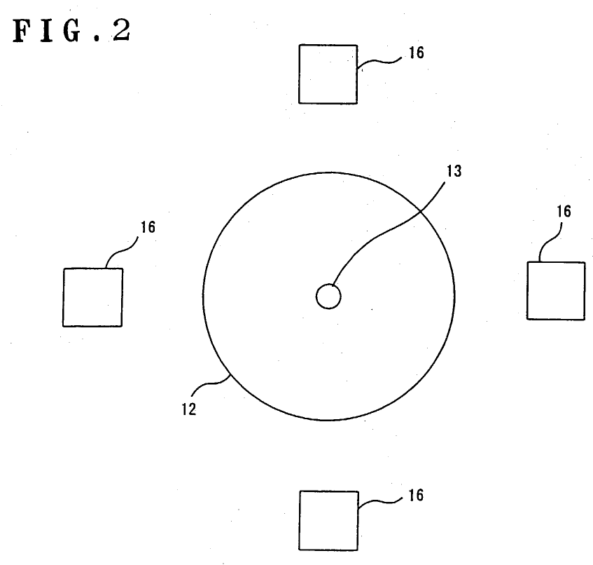

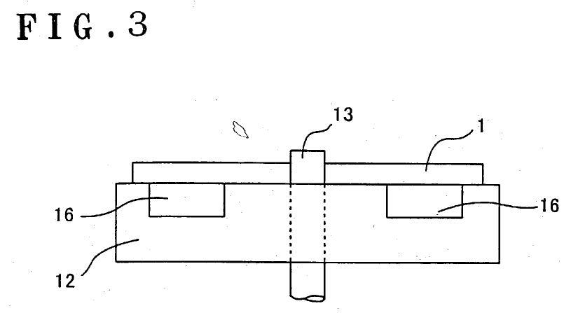

The heaters 16 are placed, for example, around the rotating stage 12 in order to keep the temperature around a radially outer portion of the substrate 1 higher than that of a radially inner portionof the substrate 1 by, for example, heating the substrate 1 placed on the rotating stage 12. The heaters 12, comprising a drier, a lamp for heating, a hot plate and so on, are provided around the rotating stage 12 and the number of heaters is properly determined depends on the heating conditions as shown in FIG. 2. Alternatively, the heaters 16 may be implanted within the rotating stage 12 as shown in FIG. 3. In the case in FIG. 3, the heaters 16 only heat the radially outer and the radially inner portion of the substrate 1 placed on the rotating stage 12 so as to keep the temperature around the radially outer portion of the substrate 1 higher than that of the radially inner portion of the substrate 1. The heaters 16 can be of any configuration which provides a radial temperature gradient on the substrate 1 placed on the rotating stage 12 so that the temperature around the radially outer portion of the substrate 1 is higher than that of the radially inner portion of the substrate 1.

The controller 17 is connected to the motor 20, the heaters 16 and the resin supplier 14, respectively. The controller 17 controls the number of rotation, a rotating period, an on-off operation of the heaters, and a set-point of the temperature and a heating period of the heaters. Furthermore, the controller 17 controls a quantity of resin to be dripped on the substrate 1 from the resin supplier 14 and a timing of the dripping.

The substrate 1 introduced to the apparatus 10 described above, whereon the recording area 2 is already formed on one main surface, is a type of substrate suitable for an optical disc which is capable for recording and/or reproducing by means of a laser beam having a short wavelength such as a blue laser.

The substrate 1 is made from resin materials such as acrylic resin, polycarbonate(PC) resin and polyorefin resin, from glass materials or the like. When the substrate 1 is made from resin material, polycarbonate is a preferable choice from the view points of its features such as formability, water absorption, and heat resisting properties. Lands and grooves are provided on one main surface of the substrate 1 which correspond to the information signals. These lands and grooves are formed by injection-molding when it is made from resin materials. When the substrate 1 is formedby injection-molding, the thickness of the substrate 1 should not be less than 0.3 mm preferably. If the substrate 1 is too thin, difficulty is created in transferring the lands and grooves and also the substrate 1 is insufficiently stiff, i.e., too flexible.

The recording area 2 comprises one of the optical recording layers such as a non-rewritable type, a write once read many type and a phase-change type. The optical recording layer of the non-rewritable type comprises a metal layer such as Au, Al, Al alloy, Ag, and Ag alloy. The optical recording layer of the write once read many type comprises an organic dye such as cyanine group, phthalocyanine group and azo group, or an alloy material having a low melting point such as Te, Bi, Se, and Sn. The optical recording layer of the phase-change type comprises a recording layer such as GeInSbTe, AgInSbTe, and GeSbTe.

Next, a method for forming the light-transmitting layer on the optical disc which is a first embodiment using the manufacturing apparatus 10 described above will be described hereinafter. First of all, the optical disc 1 as the substrate whereon the recording area 2 is already formed is fastened on the rotating stage 12 so as to align the center of the disc to the spindle 13, thus the optical disc 1 is fixed to the rotating stage 12.

An annular spacer 26 having a thickness of, for example, 0.1 mm is then fit to the spindle 13 to cover the non-recording area around the radially inner portion of the optical disc 1. Then, a UV curable resin 3 in the liquid phase is dripped annularly from the resin supplier 14 on the recording area along the radially outer portion of the annular spacer 26. A type of resin used for the UV curable resin 3 has features such that the resin is cured by UV irradiation to exhibit a transmissive characteristic of an incident light inputs from the outside, and that the resin has a viscosity of, for example, more than or equal to 2500 Pas at 25° C. In this embodiment, the UV curable resin having a viscosity of 2800 Pas at 25° C. is used.

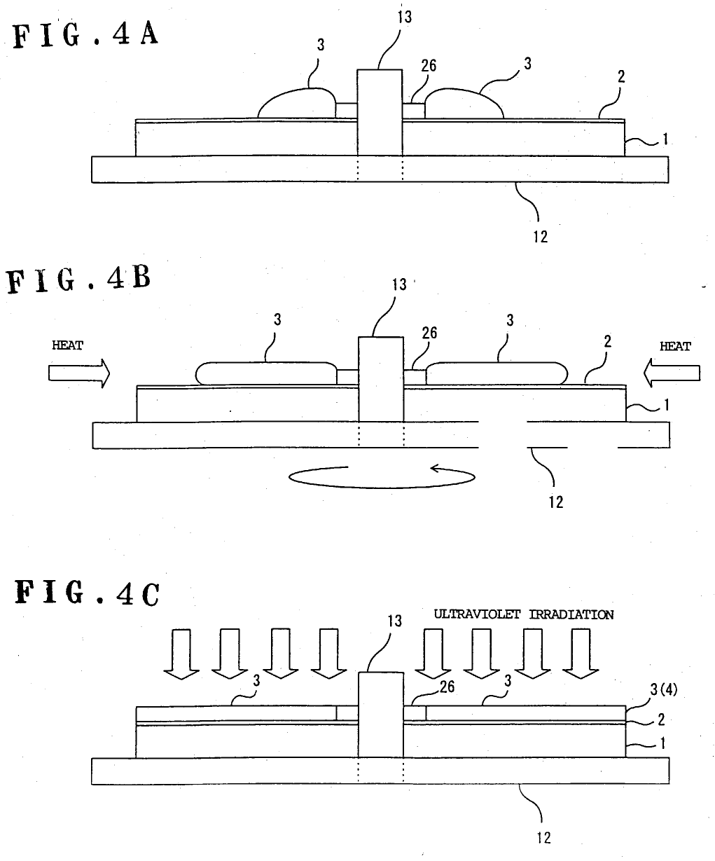

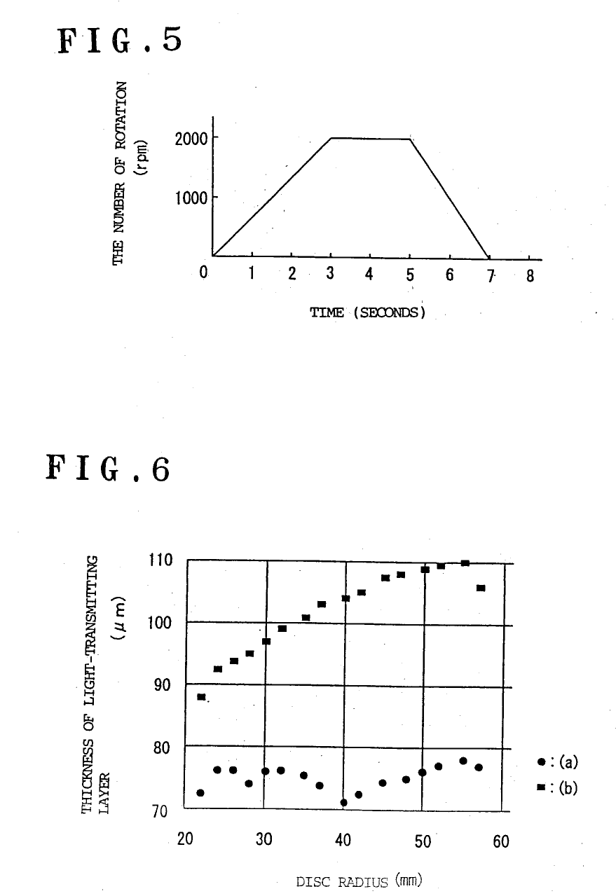

After dripping the resin, the substrate 1 is rotated by the rotating stage 12 while keeping the temperature around the radially outer portion of the substrate higher than that of the radially inner portion of the substrate by applying heat from the radially outer portion by means of the heaters 16 as shown in FIG. 4B. A rotating condition of the rotating stage 12 of this embodiment is shown in FIG. 5. In FIG. 5, a variation of the number of rotation of the rotating stage 12 with time is shown. As can be seen in FIG. 5, the rotating stage 12 reaches 2000 rpm in 3 seconds after the start of the rotation, keeps 2000 rpm for 2 seconds, and then stops rotation in 2 seconds, which is controlled by the control signals from the controller 17. During this rotation, the resin 3 is allowed to spread or flow in a radially outward direction over the substrate to form a thin layer due to its viscosity and the centrifugal force generated by the rotation. When a hot plate is used as the heaters 16, the temperature of the hot plate is set to keep at 80° C.

Next, an ultraviolet light is irradiated from a light source such as an ultraviolet lamp (not shown) toward the resin 3 that is already expanded over the entire surface of the substrate 1 as shown in FIG. 4C in order to cure the resin for forming the light-transmitting layer 4, thus manufacturing of the optical disc is completed.

A thickness of the light-transmitting layer 4 is set to a desired value so as to comply with the wavelength of the laser light used for the optical disc 1. For example, it is preferable to form the layer having a thickness not more than 177 μm when a blue laser (its wavelength is around 400 nm) is used. Although it is preferable to decrease the thickness of the light-transmitting layer as thin as possible to comply with a lens of an optical pick-up system having a large numerical aperture, the layer should have at least a specified thickness, preferably around 100 μm (0.1 mm), in order to protect the recording layer 2. It should be noted that the annular spacer 26 used in the above method is not a mandatory requirement.

In order to record and/or reproduce information signals on the recording layer 2, a laser light is irradiated which passes through the light-transmitting layer 4 toward the optical disc manufactured by the method mentioned above.

FIG. 6 depicts a variation of the thickness of the light-transmitting layer 4 along a radial direction on the optical disc 1 manufactured according to this embodiment. In FIG. 6, a series of plots denoted by (a) depicts a radial distribution of the thickness of the light-transmitting layer 4 on the optical disc 1 manufactured according to this embodiment. For the purpose of comparison, a series of plots denoted by (b) is also shown on the same graph which depicts a variation of the thickness of the light-transmitting layer along a radial direction on the optical disc manufactured without using the heaters 16 during the rotation of the rotating stage 12. As can be seen from the graph, when no heating is applied on the substrate 1 so that the substrate 1 having no temperature gradient along the radial direction during the expansion of the resin by the rotation, the variation of the thickness of the light-transmitting layer 4 exhibits a tendency of substantially linear increase along the radial direction from a radially inner portion to a radially outer portion. On the other hand, when the heating is applied on the substrate 1 so that the substrate 1 having the temperature gradient along the radial direction from a radially outer portion to a radially inner portion during the expansion of the resin by the rotation, the variation of the thickness of the light-transmitting layer 4 exhibits no increase along the radial direction and thus exhibits a uniform distribution along the radial direction over the entire optical disc which is obtained within a short rotating period of the rotating stage 12. That is to say, it can be considered that the heating applied to the substrate from the radially outer portion of the substrate during the rotational expansion of the resin 3 dripped on the substrate 1 as described above causes the temperature increase around a local area of the substrate as the spreading resin 3 reaches the radially outer portion of the substrate 1, which allows to decrease the viscosity of the resin 3, thus exhibiting no increase of the thickness of the light-transmitting layer around the radially outer portion of the substrate.

Although the average thickness of the light-transmitting layer 4 formed by the heating applied from the radially outer portion of the substrate shows 75 μm in FIG. 6, a proper selection regarding a type and viscosity of the resin 3 or a proper control over the number of rotation of the rotating stage 12 by the controller 17 allows to have the average layer thickness of 0.1 mm in forming the light-transmitting layer 4.

The temperature of the heater 16 is set to have a uniform layer thickness over the entire surface of the substrate 1 in forming the light-transmitting layer 4 under the suppressing conditions against a generation of warp or deformation of the substrate 1.

Next, method to form the light-transmitting layer on the optical disc which is a second embodiment using the manufacturing apparatus 10 of the present invention will be described hereinafter. In the embodiment, the light-transmitting layer 4 comprises a film which transmits the ultraviolet light and a UV curable resin which bonds the film on the recording area 2 of the substrate 1.

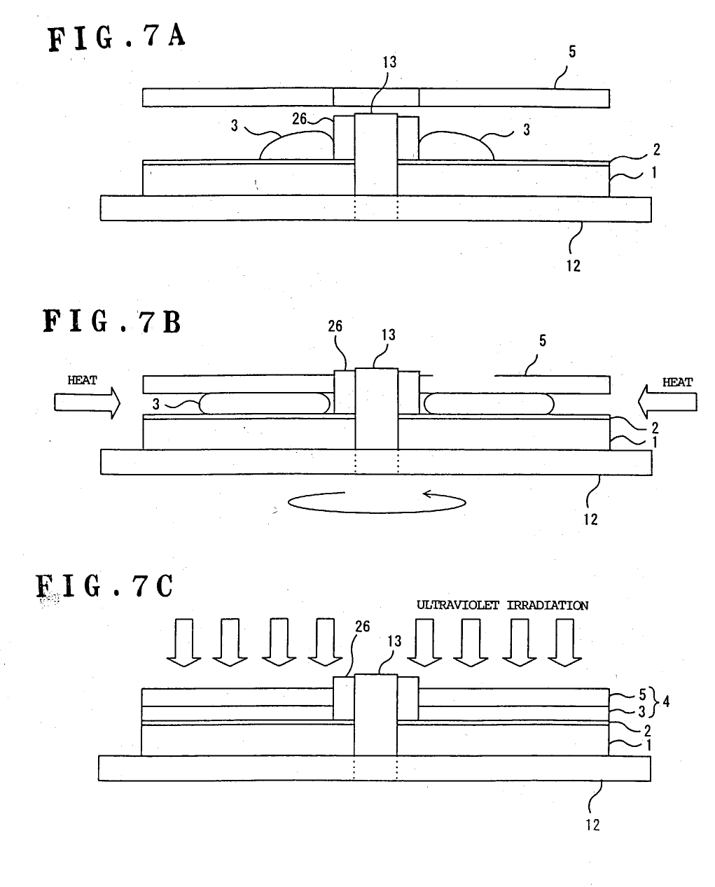

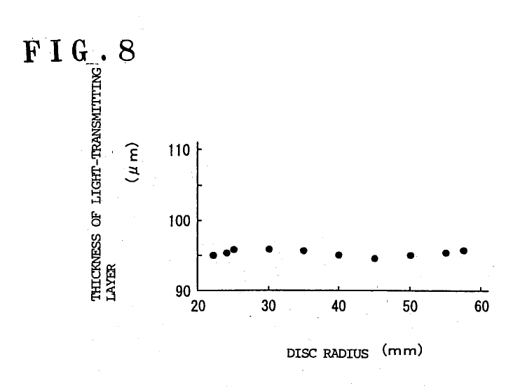

First of all, an optical disc 1 as a substrate, whereon a recording area 2 is already formed, is fit to the spindle 13 so as to align the center of the disc, thus the.substrate is fastened on the rotating stage 12 to fix the position of the substrate as shown in FIG. 7A.

An annular spacer 26 having a thickness of, for example, 0.1 mm is then fit to the spindle 13 to cover the non-recording area around the radially inner portion of the optical disc 1. Then, a UV curable resin in the liquidphase is dripped annularly, that is, on a circle which is concentric with the rotating shaft 18 of the rotating stage 12, from the resin supplier 14 on the recording area along the radially outer portion of the annular spacer 26. A type of resin used for the UV curable resin 3 has features such that the resin is cured by UV irradiation to exhibit a transmissive characteristic of an incident light inputs from the outside, and that the resin has a viscosity of, for example, 20 through 1000 Pas at 25° C. In this embodiment, the UV curable resin 3 having a viscosity of 65 Pas at 25° C. is used.

Next, a PC film 5 of 85 μm thickness with an opening in its center and having a transmissive characteristic of the ultraviolet light is fit to the spindle 13 so as to align the center of the film, thus the PC film overlaps the recording area 2 of the substrate 1 with the UV curable resin in between.

After dripping the resin and overlapping the PC film 5, the substrate 1 is rotated by the rotating stage 12 while keeping the temperature around the radially outer portion of the substrate higher than that of the radially inner portion of the substrate by applying heat from the radially outer portion by means of the heaters 16 as shown in FIG. 7B. The rotating condition of the rotating stage 12 of the embodiment is controlled by the controller 17 so that the rotation is kept at 3000 rpm for 6 seconds when the number of the rotation reaches 3000 rpm after the start of the rotation, then kept at 4000 rpm for 3 seconds, and then stopped. Activation of the heaters 16 for the substrate 1, which therefore provides a radial temperature gradient on the substrate 1 so that the temperature around the radially outer portion of the substrate 1 is higher than that of the radially inner portion of the substrate 1, is limited during the rotation of the rotating stage 12 at 3000 rpm. During this period, the resin is allowed to spread or flow in a radially outward direction over the substrate to form a thin layer due to its viscosity, the weight of the PC film, and the centrifugal force generated by the rotation.

Next, an ultraviolet light is irradiated from a light source such as an ultraviolet lamp (not shown) through the PC film 5 toward the resin that is already expanded over the entire surface of the substrate 1 as shown in FIG. 7C in order to cure the resin for forming the light-transmitting layer 4 which is made from the cured resin 3 and the PC film 5, thus manufacturing of the optical disc is completed.

A thickness of the light-transmitting layer 4 is set to a desired value so as to comply with the wavelength of the laser light used for the optical disc 1. For example, it is preferable to form the layer having a thickness not more than 177 μm when a blue laser (its wavelength is around 400 nm) is used. Although it is preferable to decrease the thickness of the light-transmitting layer as thin as possible to comply with a lens of an optical pick-up system having a large numerical aperture, the layer should have at least a specified thickness, preferably around 100 μm, in order to protect the recording layer 2.

In order to record and/or reproduce information signals on the recording layer 2, a laser light is irradiated which passes through the light-transmitting layer 4 toward the optical disc manufactured by the method mentioned above.

FIG. 8 depicts a variation of the thickness of the light-transmitting layer 4 along a radial direction on the optical disc manufactured according to this embodiment. In FIG. 8, a series of plots depicts a radial distribution of the thickness of the light-transmitting layer on the optical disc manufactured according to this embodiment. As can be seen from the graph in FIG. 6, for example, when no temperature gradient is applied on the substrate during the expansion of the resin by the rotation, the variation of the thickness of the light-transmitting layer generally exhibits a tendency of substantially linear increase along the radial direction from a radially inner portion to a radially outer portion. On the other hand, when the temperature gradient is applied to the substrate along the radial direction so that the temperature around the radially outer portion becomes higher than that around the radially inner portion during the similar expansion of the resin by the rotation, the variation of the thickness of the layer exhibits no increase along the radial direction and thus exhibits a uniform distribution along the radial direction over the entire optical disc, even the light-transmitting layer 4 has a configuration made from both the ultraviolet transmissive film 5 and the resin 3. That is to say, it can be considered that the temperature gradient applied to the substrate along the radial direction so that the temperature around the radially outer portion becomes higher than that around the radially inner portion during the rotational expansion of the resin dripped on the substrate as described above causes decreasing of the viscosity of the resin by heating as the spreading resin reaches the radially outer portion of the substrate, thus exhibiting no increase of the thickness of the light-transmitting layer around the radially outer portion of the substrate.

The thickness of the light-transmitting layer 4 is allowed to have an average value of 0.1 mm which is suitable for the light-transmitting layer used for the optical disc complying with, for example, the blue laser, by a proper selection of a thickness of the ultraviolet transmissive film or by a proper control by the controller 17 over the type and viscosity of the resin 3 or the number of rotation of the rotating stage 12.

As described above, it is possible to form the light-transmitting layer 4 having a uniform thickness over the entire surface of the substrate, by keeping the temperature around the radially outer portion of the rotating substrate 1 higher than that around the radially inner portion of the substrate 1 during the expansion of the ultraviolet transmissive resin 3 over the entire surface of the substrate 1 which is made by the rotation of the rotating stage 12 after dripping the resin on the substrate. A special tool which has been used to obtain a layer with a uniform thickness during the expansion of the resin over the substrate is therefore not required. In addition, although long rotating periods at the specified number of rotation has been hither to required to the rotating stage 12 in order to obtain a uniform thickness for the light-transmitting layer, the heating on the radially outer portion of the substrate as described above allows to form the layer with a uniform thickness in a short period. Accordingly, the manufacturing steps of the optical disc can be simplified and also the manufacturing time of the optical disc can be saved, which allows to improve the productivity and to reduce the production cost of the optical disc.

This application is based on a Japanese patent application No. 2002-30484 which is hereby incorporated by reference.

What is claimed is:

1. Method of manufacturing an optical disc, having a recording layer and a light-transmitting layer formed on a substrate, whereon a recording and/or a reproducing of information signals are carried out by a light input through said light-transmitting layer, the method comprising the steps of;
a first step of supplying an ultraviolet curable resin in the liquid phase on a central area of the recording layer of said substrate, and expanding said ultraviolet curable resin over said recording layer while keeping the temperature around a radially outer portion of said substrate higher than that around a radially inner portion of said substrate and while rotating said substrate around a rotating shaft aligned with the center of said substrate, and
a second step of curing said expanded ultraviolet curable resin so as to form said light-transmitting layer.

2. The method according to claim 1, wherein the viscosity of said ultraviolet curable resin is not less than 2500 Pas at 25 ° C.

3. Method of manufacturing an optical disc, having a recording layer and a light-transmitting layer formed on a substrate, whereon a recording and/or a reproducing of information signals are carried out by a light input through said light-transmitting layer, the method comprising the steps of;
a supplying step of supplying an ultraviolet curable resin in the liquid phase on a central area of the recording layer of said substrate,
a first step of overlapping a resin film on said substrate whereon said ultraviolet curable resin is already supplied, and expanding said ultraviolet curable resin between said resin film and said recording layer while keeping the temperature around a radially outer portion of said substrate higher than that around a radially inner portion of said substrate and while rotating said substrate around a rotating shaft aligned with the center of said substrate, and
a second step of curing said expanded ultraviolet curable resin so as to form said light-transmitting layer together with said resin film.

4. The method according to claim 3, wherein the viscosity of said ultraviolet curable resin is between 20 through 1000 Pas at 25° C.

5. An apparatus for manufacturing an optical disc having a recording layer and a light-transmitting layer on a circular substrate, whereon a recording and/or a reproducing of information on the recording layer is carried out by a light input through said light-transmitting layer, the apparatus comprising;
a rotating stage which rotates said substrate around a rotating shaft aligned with the center of said substrate placed on the stage,
a resin supplier which supplies an ultraviolet curable resin on a central area of the substrate placed on said rotating stage,
one or more heaters provided around a radially outer portion of the substrate placed on said rotating stage, and a controller which controls said rotating stage, said resin supplier and said heaters.

6. The apparatus according to claim 5, wherein a light source is further provided to emit an ultraviolet light for curing the resin applied on said substrate.
